(19) United States
(12) Patent Application Publication
(10) Pub. No.: US 2015/0317325 A1
(43) Pub. Date: Nov. 5, 2015

(54) METHODS AND APPARATUS FOR DETECTION OF ILLICIT FILES IN COMPUTER NETWORKS

(71) Applicant: Key Cybersecurity, Inc., Dumfries, VA (US)

(72) Inventor: Shawn R. KEY, Gainesville, VA (US)

(21) Appl. No.: 14/700,757

(22) Filed: Apr. 30, 2015

Related U.S. Application Data
(60) Provisional application No. 61/986,553, filed on Apr. 30, 2014.

(51) Int. Cl. G06F 17/30

(52) U.S. Cl. CPC G06F 17/30109; G06F 17/30864

(57) ABSTRACT

In some embodiments, a method includes generating a hash value or a hash string of a suspected illicit file stored in a communication device in a computer network. The method includes comparing the hashed value of the suspected illicit file to hash values of known illicit files stored in a database. The method includes determining if the hash value of the suspected illicit file has a match with a hash value of a known illicit file stored in the database. The match can be, for example, an exact match with a known illicit file, an approximate match with a known illicit file or a match with a set of known hash values that can be generated by implementing a set of pre-determined rules. The method also includes generating an alert signal and an alert or forensic report associated with the match, if a successful match with a known illicit file or a pre-determined rule occurs. The method further includes sending the alert signal and the alert or forensic report associated with the match a law enforcement agency device.

### CROSS-REFERENCE TO RELATED APPLICATIONS

This application claims priority to U.S. Provisional Application No. 61/986,553, entitled “Methods and Apparatus for Detection of Illicit Files in Computer Networks,” filed Apr. 30, 2014, which is incorporated herein by reference in its entirety.

### BACKGROUND

Some embodiments described herein relate generally to the methods and apparatus for the location and detection of illicit files stored in communication devices associated with networks.

Communication devices associated with networks can be used to transfer, download, view and/or store illicit files such as, for example, video files and image files related to child pornography, files related to terrorism, and other crime-related files, as well as files of intellectual property and/or otherwise sensitive documents. Such networks can be, for example, a local area network (LAN), a wide area network (WAN) or a distributed network (e.g., a web-based or a cloud-based network).

Known methods of identifying illicit files stored in communication devices in a network and blocking of external illicit files that are transmitted to communication devices from the Internet (world-wide web) can be ineffective. This can be due to the extensive computational resources used to match a suspected illicit file (e.g., video file, image file, audio file, etc.) stored in a communication device to all known illicit files that exist in, for example, the entire world-wide web.

Accordingly, a need exists for methods and apparatus for proactively and speedily identifying illicit files stored on communication devices in networks without alerting the user of those communication devices.

### SUMMARY

In some embodiments, a method includes generating a hash value or a hash string of a suspected illicit file stored in a communication device in a network. The method includes comparing the hashed value of the suspected illicit file to hash values of known illicit files stored in a database. The method includes determining if the hash value of the suspected illicit file has a match with a hash value of a known illicit file stored in the database. The match can be, for example, an exact match with a known illicit file, an approximate match with a known illicit file or a match with a set of known hash values that can be generated by implementing a set of pre-determined rules. The method also includes generating an alert signal and an alert or forensic report associated with the match, if a successful match with a known illicit file or a pre-determined rule occurs. The method further includes sending the alert signal and the alert or forensic report associated with the match to a law enforcement agency device.

### BRIEF DESCRIPTION OF THE DRAWINGS

FIG. 1 is a block diagram showing a system for matching hash values of suspected files stored in communication devices with hash values of known illicit files, according to an embodiment.

FIG. 2 is a schematic illustration of a system for detecting illicit files, according to an embodiment.

FIG. 3A is a flow chart illustrating a method for storing a representation of known illicit files in the database of the enterprise server, according to a first configuration.

FIG. 3B is a flow chart illustrating a method for storing a representation of known illicit files in the database of the enterprise server, according to a second configuration.

FIG. 4A is a flow chart illustrating a method for detecting the presence of a suspected illicit file in a communication device, according to a first configuration.

FIG. 4B is a flow chart illustrating a method for detecting the presence of a suspected illicit file in a communication device, according to a second configuration.

FIG. 4C is a flow chart illustrating a method for detecting the presence of a suspected illicit file in a communication device, according to a third configuration.

### DETAILED DESCRIPTION

In some embodiments, a method includes generating a hash value or a hash string of a suspected illicit file stored in a communication device in a computer network. The method includes comparing the hashed value of the suspected illicit file to hash values of known illicit files stored in a database. The method includes determining if the hash value of the suspected illicit file has a match with a hash value of a known illicit file stored in the database. The match can be, for example, an exact match with a known illicit file, an approximate match with a known illicit file or a match with a set of known hash values that can be generated by implementing a set of pre-determined rules. The method also includes generating an alert signal and an alert or forensic report associated with the match, if a successful match with a known illicit file or a pre-determined rule occurs. The method further includes sending the alert signal and the alert or forensic report associated with the match to a law enforcement agency device.

As used in this specification, a module can be, for example, any assembly and/or set of operatively-coupled electrical components associated with performing a specific function(s), and can include, for example, a memory, a processor, electrical traces, optical connectors, software (that is stored in memory and/or executing in hardware) and/or the like.

As used in this specification, an illicit file can be, for example, photographs, video clips, cartoons, pictures, blog entries, articles associated with child pornography, or other underage sexual activity, banned weapons training or other terrorism related activity, and/or human trafficking, etc. Furthermore, illicit files can also be or in the alternative include sensitive files of an enterprise, for example, intellectual property or trade secrets, business confidential documents, etc.

As used in this specification, an enterprise may refer to any organization such as a business, a corporation, a firm, an educational entity, or any other organization, regardless of the size of the organization.

As used in this specification, an administrator can be, for example, any person that is a network administrator of an organization, an information technology analyst (IT) of an organization, a security official associated with an organization, a law enforcement agency official, and/or the like. Moreover, as used in this specification, an administrator may or may not be the owner of the communication device.

As used in this specification, the singular forms “a,” “an” and “the” include plural referents unless the context clearly dictates otherwise. Thus, for example, the term “a communication device” is intended to mean a single communication device or a combination of communication devices.

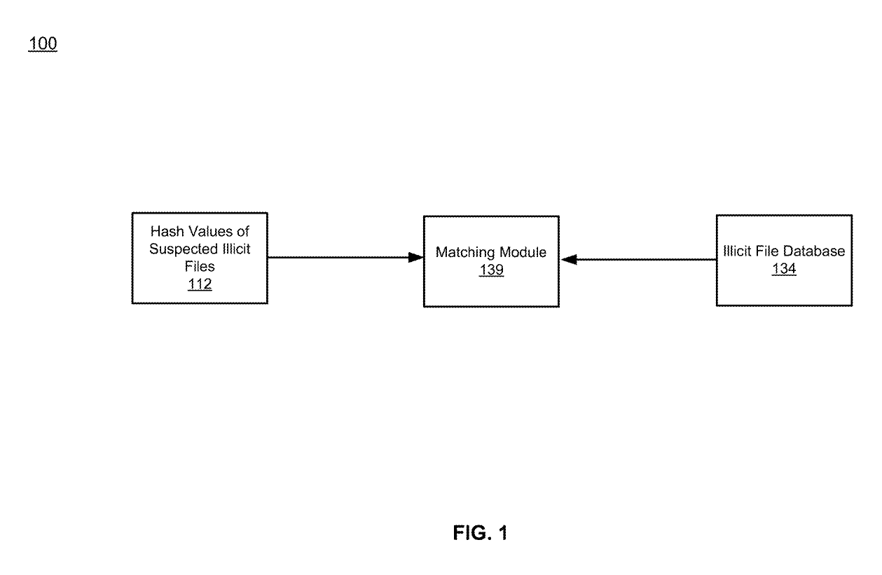

FIG. 1 is a block diagram showing a system for matching hash values of suspected files stored in communication devices with hash values of known illicit files, according to an embodiment. The process 100 includes generation of hash values or hash strings of any set of files stored in a communication device(s) associated with, for example, any corporate enterprise, K-12 educational institution, university, community college, medical service provider, government organization, and/or the like. The files could be for example, image files (e.g., JPEG files, TIFF files, GIF files, etc.), word processor files (e.g., Microsoft® Word files, etc.), portable document files (e.g., PDF files), spreadsheets, and/or the like. The files can be hashed by an application that is installed and running locally on the communication device (not shown in FIG. 1). The hash values of the suspected illicit files 112 are sent from the communication device (not shown in FIG. 1) to a matching module 139 via, for example, the Internet. The matching module 139 can be and/or include a hardware module(s) and/or a software module(s) stored in memory and/or executed in a processor of an external device such as, for example, a server (not shown in FIG. 1) that can use one or more hash value comparison techniques to compare or match the hash values generated of the suspected illicit file to that of stored hash values of known illicit files. The hash values or hash strings of known illicit files are stored in the illicit file database 134. The illicit file database 134 can be a lookup table or a dedicated memory space in an external device such as, for example, a server (not shown in FIG. 1) that can store hash values or hash string of known illicit files. In some instances, the contents of illicit file database 134 can be populated by law enforcement agencies such as, for example, the Federal Bureau of Investigation (FBI), the Drug Enforcement Administration (DEA), the Central Intelligence Agency (CIA), local police office, local Sheriff's office, a local Highway Petrol's office, and/or the like. In other instances, the contents of illicit file database 134 can be populated by the external device (e.g., a server) searching the Internet (or World Wide Web) to locate and detect illicit files as described above. In such instances, such illicit files are hashed by a hashing module in the external device (not shown in FIG. 1) and stored in the illicit file database 134.

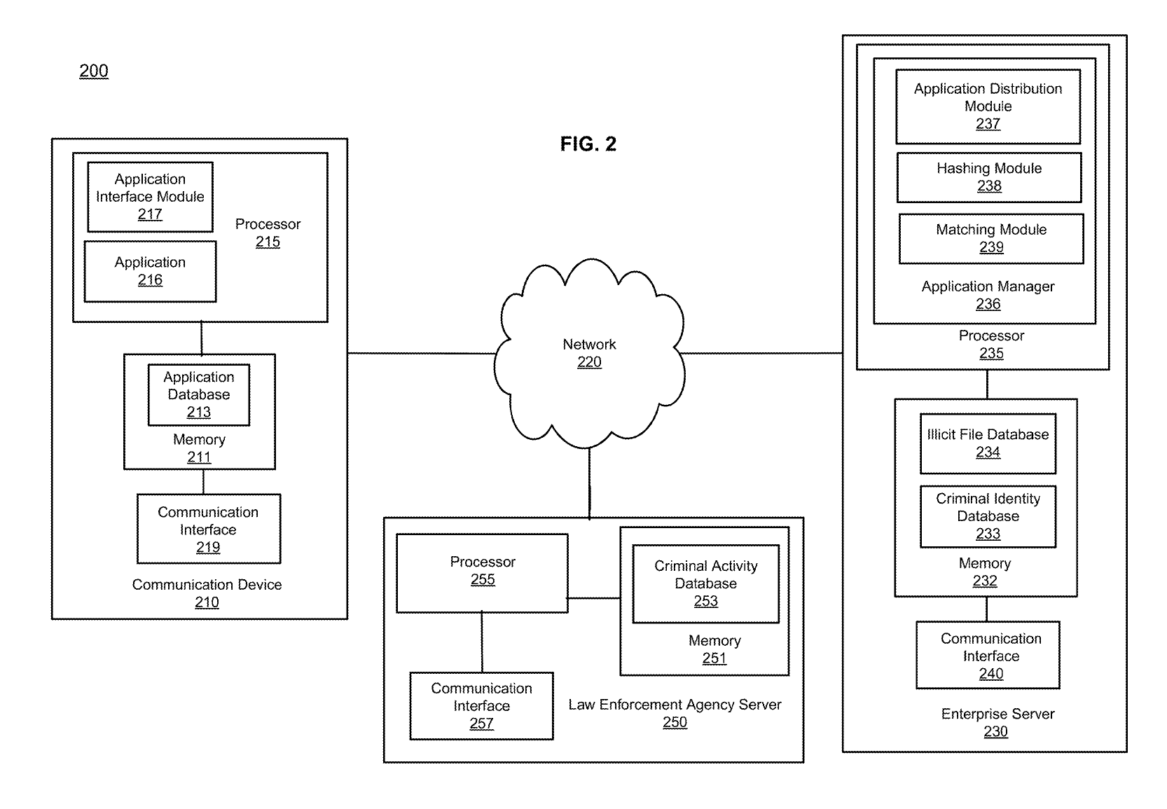

FIG. 2 is a schematic illustration of a system for detecting illicit files, according to an embodiment. An illicit file detection system 200 shown in FIG. 2 includes a communication device 210, an enterprise server 230, a network 220, and a law enforcement agency server 250. The network 220 can be any type of network (e.g., a local area network (LAN), a wide area network (WAN), a virtual network, and/or a telecommunications network) implemented as a wired network and/or a wireless network and can include an intranet, an Internet Service Provider (ISP) and the Internet, a cellular network, and/or the like. As described in further detail herein, in some configurations, for example, the communication device 210 and/or the law enforcement agency server 250 can be connected to the enterprise server 230 via network 220.

The communication device 210 can be associated with a physical or logical storage component or device or a portion of a logical memory that can be located on a personal communication device, a communication device associated with/included with any type of network (e.g., LAN, WAN, etc.) and/or a communication device associated with/included with a cloud computing network. For example, in some instances, the communication device 210 can be any personal communication device such as a desktop computer, a laptop computer, a personal digital assistant (PDA), a standard mobile telephone, a tablet personal computer (PC), and/or so forth. In other instances, the communication device 210 can be an enterprise computing device/system such as a database, a server, a Storage Area Network (SAN), and/or the like. The communication device 210 can be associated with any organization such as, for example, any corporate enterprise, K-12 educational institution, university, community college, medical service provider, government organization, and/or the like. In the example shown in FIG. 2, the communication device 210 includes a memory 211, a processor 215 and a communication interface 219. The memory 211 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 211 can store instructions to cause the processor 215 to execute modules, processes and/or functions associated with the communication device 210 and/or the illicit file detection system 200. The memory 211 includes an application database 213.

The application database 213 can be a lookup table or a dedicated memory space that can store data and/or instructions associated with executing an application 216 in the processor 215 of the communication device 210. In one example, such data and/or instructions can include instructions for implementing one or more different hash function generation techniques to define the hash value or hash sting of a suspected illicit file using modern multipart hashes and hierarchical hash chains (e.g., MD5, SHA-1, SHA256, SSDeep, etc.). In another example, such data can include an installation file that can install the application 216 on the communication device 210.

The processor 215 can be, for example, a general purpose processor, a Field Programmable Gate Array (FPGA), an Application Specific Integrated Circuit (ASIC), a Digital Signal Processor (DSP), and/or the like. The processor 215 can run and/or execute applications, modules, processes and/or functions associated with the communication device 210 and/or the illicit file detection system 200. The processor 215 includes the application 216 and an application interface module 217. Alternatively, the processor 215 can execute the application 216 and/or the application interface module 217, which are stored in memory 211. Note that FIG. 2 shows only one communication device 210 in the illicit file detection system 200 as an example only for simplicity, and not a limitation. The illicit file detection system 200 can include multiple communication devices that are associated with any organization such as, for example, a corporate enterprise, K-12 educational institution, university, community college, medical service provider, government organization, and/or the like.

The application 216 can be received, for example, via the network 220 from the enterprise server 230. In some configurations, the application 216 can be and/or include a hardware module(s) and/or a software module(s) (stored in memory 211 and/or executed in a processor 215) that is installed and executable directly at the communication device 210. The application 216 can cause the processor 215 to execute sub-modules, processes and/or functions associated with the communication device 210 and/or the illicit file detection system 200. The application 216 can be installed on a communication device 100 by an administrator and can run in the background on the communication device 210 without active knowledge of a user of the communication device 210. The application 216 can identify and locate suspected illicit files stored in the communication device 210. Such illicit files can include, for example, child pornography files, files related to terrorism, or any other criminal activity-related files. The application 216 can include a hashing engine (not shown explicitly in FIG. 2) that can apply a hash function to any file stored in the communication device 210 to generate a fixed-sized bit string (i.e., the hash value or the hash string). In some instances, the hash value or string generated for a file can have a high degree of exclusivity such that any (accidental or intentional) change to the data associated with the file may (with very high probability) change the hash value of the file. The data in the file that is encoded by the hash function can be referred to as the message, and the hash value generated can be referred to as the message digest. The hash value that represents a particular file stored in the communication device 210 can be computed for any given file (i.e., message) stored in the communication device 210. Additionally, hash value for the file is generated in such a manner that: it may not be feasible to re-generate the file back from its given hash value; it may not be feasible to modify a file without changing the hash value of the file, and; it may not be feasible to find two different files with the same hash value. For example, changing the brightness of an image file (e.g., a TIFF file, a JPEG file, a GIF file, etc.) or cropping an image file will change the hash value of the file. The application 216 can implement different hash function generation techniques to define the hash value or hash sting of a suspected file using modern multipart hashes and hierarchical hash chains (e.g., MD5, SHA-1, SHA256, SSDeep, etc.). After the hashing process of the suspected illicit file is complete, the application 216 can send the hash value of the suspected illicit to the enterprise server 230 via the network 220.

The application interface module 217 can be and/or include a hardware module(s) and/or a software module(s) (stored in memory 211 and/or executed in a processor 215) that controls input from and/or output to a display unit at the communication device 210 or the enterpriser server 230 (not shown in FIG. 2). The display unit can be, for example, a liquid crystal display (LCD) unit or a light emitting diode (LED) alpha-numeric display unit that can display a graphical user interface (GUI) generated by the application 216. The GUI displayed on the display unit via the application interface module 217 can allow an administrator of the communication device 210 to interact with the application 216. The GUI may include a set of displays having message areas, interactive fields, pop-up windows, pull-down lists, notification areas, and buttons that can be operated by the administrator. The GUI may include multiple levels of abstraction including groupings and boundaries. It should be noted that the term “GUI” may be used in the singular or in the plural to describe one or more GUI's, and each of the displays of a particular GUI may provide the administrator of the communication device 210 with information for the application 216. It is to be noted that in other instances, the graphical user interface (GUI) associated with the application 216 can be displayed on the enterprise server 230 (i.e., instead of on the communication device 210). In such instances, the administrator of the communication device 210 will interact with the application 216 remotely from the enterprise server 230 and the communication device 210 may not include the application interface module 217 and may not receive information provided to the administrator.

The communication device 210 also includes a communication interface 219, which is operably coupled to the communication interfaces of the different servers described in FIG. 2. The communication interface 219 can include one or multiple wireless port(s) and/or wired ports. The wireless port(s) in the communication interface 219 can send and/or receive data units (e.g., data packets) via a variety of wireless communication protocols such as, for example, a wireless fidelity (Wi-Fi®) protocol, a Bluetooth® protocol, a cellular protocol (e.g., a third generation mobile telecommunications (3G) or a fourth generation mobile telecommunications (4G) protocol), 4G long term evolution (4G LTE) protocol), and/or the like. In some instances, the wired port(s) in the communication interface 219 can also send and/or receive data units via implementing a wired connection to the enterprise server 230 and/or the law enforcement agency server 250 via the network 220. In such instances, the wired connections can be, for example, twisted-pair electrical signaling via electrical cables, fiber-optic signaling via fiber-optic cables, and/or the like.

The enterprise server 230 can be, for example, a web server, an application server, a proxy server, a telnet server, a file transfer protocol (FTP) server, a mail server, a list server, a collaboration server and/or the like. The enterprise server 230 includes a memory 232, a processor 235 and a communication interface 240. The memory 232 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 232 can store instructions to cause the processor 235 to execute modules, processes and/or functions associated with the enterprise server 230 and/or the illicit file detection system 200. The memory 232 includes an illicit file database 233 and a criminal identity database 234.

The criminal identity database 233 can be a lookup table or a dedicated memory space that can store the identities of known people associated with criminal activity such as, for example, child pornography, illegal gambling, terrorism, organized crime, and/or the like. The stored information associated with criminal identities can be, for example, name, social security number, date of birth, place of birth, driver's license number, arrest record locator number, police record number, a list of criminal activities associated with a said criminal, a list of known illicit files that can been created or accessed by a criminal, and/or the like. The criminal identity database 233 can store information sent by a variety of law enforcement agencies and/or information produced by a search engine of the enterprise server 230 (not shown in FIG. 2) by locating and detecting illicit files in the Internet. The contents of the criminal identity database 233 can be accessed by the application manager 236 for matching the hash values of suspected illicit files stored in a communication device 210 in an organization with that of known illicit files and also for monitoring criminal activity related to an organization or a locality. Hence, the illicit file detection system 200 allows the production of customizable databases (e.g., illicit file database 234 and the criminal identity database 233) by a data import feature described above that can be, for example, used by security and forensics teams to detect and locate suspected illicit files stored in communication devices 210 associated with any organization.

The illicit file database 234 can be a lookup table or a dedicated memory space that can store hash values or hash strings of known illicit files. In some instances, the contents of illicit file database 234 can be obtained by the enterprise server 230 from different law enforcement agencies such as, for example, the Federal Bureau of Investigation (FBI), the Drug Enforcement Administration (DEA), the Central Intelligence Agency (CIA), local police office, local Sheriff's office, a local Highway Petrol's office, and/or the like. In some instances, the enterprise server 230 can receive hash values or hash strings of known illicit files from a law enforcement agency server 250. In such instances, the enterprise server can compare the hash value of the newly-received illicit file to the currently-stored hash values of known illicit files in the illicit file database 234 via the matching module 239. If no match is found, the enterprise server can add the hash value or hash string of the new illicit file to the illicit file database 234.

In other instances, the enterprise server 230 can receive original (i.e., unhashed) copies of the known illicit files from the law enforcement agency server 250. In such instances, the enterprise server 230 can implement one or more different hash function generation techniques to define the hash value or hash stings of the known illicit files using modern multipart hashes and hierarchical hash chains (e.g., MD5, SHA-1, SHA256, SSDeep, etc.) via the hashing module 238 (see detailed discussion below). In such instances, the enterprise server can compare the hash value of the newly-received illicit file to the currently-stored hash values of known illicit files in the illicit file database 234 via the matching module 239. If no match is found, the enterprise server can add the hash value or hash string of the new illicit file to the illicit file database 234.

In other instances, the contents of illicit file database 234 can be obtained by a searching engine (not shown explicitly in FIG. 2) in the enterprise server 230 that searches the Internet (or world-wide web) via the network 220 to locate and detect illicit files as described above. In some instances, the search engine can execute an algorithm that can detect different features of a suspected illicit file found in the Internet such as, for example, the skin tone of a person in an image file, the facial features of a person in an image file, the density of hair of a person in an image file, the presence of sharp objects or features in an image file (e.g., objects that can represent a weapon), and/or a collection of one or more indicators, numbers or any other features that convey an idea or meaning in the suspected illicit file found in the Internet. In other instances, the search engine can be run in the presence of an administrator to detect features that convey an idea or meaning in the suspected illicit file found in the Internet. After detection of the suspected illicit file(s) in the Internet, the enterprise server 230 can implement one or more hash function generation techniques to produce the hash value or hash sting of the suspected illicit files obtained from the Internet as described above (e.g., using modern multipart hashes and hierarchical hash chains). In such instances, the enterprise server can compare the hash value of the newly-obtained illicit file to the currently stored hash values of known illicit files in the illicit file database 234 via the matching module 239. If no match is found, the enterprise server can add the hash value or hash string of the newly-obtained illicit file to the illicit file database 234. It other instances, the contents of illicit file database 234 can be obtained from different social organizations such as, for example, the greater research against child exploitation (GRACE) proprietary database. In yet other instances, the contents of illicit file database 234 can be obtained from the communication device 210 where a hash value of a file stored in the communication device matches with a hash value generated from implementing a set of rules or concepts that are pre-defined, for example, by the administrator.

The processor 235 can be, for example, a general purpose processor, a Field Programmable Gate Array (FPGA), an Application Specific Integrated Circuit (ASIC), a Digital Signal Processor (DSP), and/or the like. The processor 235 can run and/or execute applications, modules, processes and/or functions associated with the enterprise server 230 and/or the illicit file detection system 200. The processor 235 includes an application manager 236. The application manager 236 includes an application distribution module 237, a hashing module 238 and a matching module 239. The application distribution module 237 can be a hardware module(s) and/or software module(s) (stored in memory 232 and/or executed in processor 235) that can send application files (e.g., executable files) to different communication devices 210 associated with an organization including, for example, authenticated and registered customers of the enterprise. The application manager 236 can send the application file(s), for example, as executable file(s), via the network 220 to the communication device 210. Such an executable file(s) can then be installed locally by the processor 215 on the communication device 210 to define application 216.

The hashing module 238 can be a hardware module(s) and/or software module(s) (stored in memory 232 and/or executed in processor 235) that can apply a hash function, for example, to any file obtained either from the Internet or from a law enforcement agency server 250 to generate a fixed-sized bit string (i.e., the hash value or the hash string), such that any (accidental or intentional) change to the data associated with the file will (with very high probability) change the hash value of the file. The data in the file that can be encoded by the hashing module 238 in such a manner that: it may not be feasible to re-generate the file back from its given hash value; it may not be feasible to modify a file without changing the hash value of the file, and; it may not be feasible to find two different files with the same hash value. For example, changing the brightness of an image file (e.g., a TIFF file, a JPEG file, a GIF file, etc.) or cropping an image file will change the hash value of the file. The hashing module 238 can implement high sensitivity and selectivity hash function generation techniques to define the hash value or hash string of a file using modern multipart hashes and hierarchical hash chains (e.g., MD5, SHA-1, SHA256, SSDeep, etc.).

The matching module 239 can be a hardware module(s) and/or software module(s) (stored in memory 232 and/or executed in processor 235) that can compare the hash value generated for any file stored in the communication device and/or received from the law enforcement agency server 250 and/or received from the Internet via the network 220 to the hash values of a known illicit files that are stored in the illicit file database 234 of the enterprise server 230. The matching module 239 can also use other hash value comparison methods to compare the hash values generated of a suspected file to that of stored hash values of known illicit files as described above. In some instances, it is desirable for the matching module 239 to be able to perform fast comparison of calculated on-the-fly hash values of a suspected file with the hash values of known illicit files stored in the illicit file database 234. Additionally, the matching module 239 can execute a myriad of fuzzy hashing match algorithms to detect altered and modified forms of known (original) illicit files that can either be obtained form the communication device 210 and/or obtained from the law enforcement agency server 250 and/or obtained from the Internet (e.g., a cropped known illicit image file, a known illicit image file with different brightness levels, a known illicit image file with different contrast levels, a known illicit image file generated by software filtering, etc.). Fuzzy hashing can be performed in the hashing module 238 and the comparison of fuzzy-hashed values of the (suspected) illicit files can be performed in the matching module 239. Such matching or comparisons can allow for the discovery of potentially incriminating illicit files (e.g., image files, WORD files, PDF files, spreadsheets, etc.) that may not be located using traditional hashing and comparison methods.

The use of fuzzy hashing involves the matching module 239 searching for documents that are similar but not exactly the same to a known illicit file. Such modified files are also known as homologous files. Homologous files have identical strings of binary data; however, they are not exact duplicates. In one example, homologous files can be two substantially identical word processor files, with a new paragraph added in the middle of one of the files. To locate homologous files, the two files are hashed traditionally by the hashing module 238 (or the application 216) in segments to identify the strings of identical data. In another example, homologous files can be two image files, with the first file being a cropped version of the second file.

Fuzzy hashing match algorithms to detect altered and modified forms of known (original) illicit files can compliment exact-match hash technologies, for example when applied to multimedia files such as image files and/or video files. For example, any variability and/or differences in the nature of file formats produces a different hash value for data included in a second file that is generated from a first file (i.e., a “source file”) via adjustments to the first file. Several instances can make exact hashing match unable to detect such suspected altered illicit files such as, for example, image or video file resizing or resampling, alteration of brightness or contrast in image and/or video files, embedding or tampering with any watermarks present in an image file, using different compression methods and/or different compression quality settings (e.g., a 95% compressed JPEG file and a 94% compressed JPEG file for the same source file will produce different hash values), modifications of image format headers and special fields, and/or the like.

Fuzzy hashing can use a series of methods to address such matching circumstances. In some instances, fuzzy hashing can involve the use of “SSDeep” hashing algorithms. In such instances, two separate SSDeep hashes of suspected homologous files can be matched “probabilistically”. The match functions return not a binary value (e.g., “true/false” or “0” and “1”), but rather a fractional value between “0” and “1”. In such instances, the matching module 239 can classify the matches with a value greater than “0.9”, for example, in the “illicit file” category, and matches with a value in the range between “0.6”-“0.9”, for example, in the “potential illicit file” category.

In other instances, fuzzy hashing can involve decompressing source images from, for example, JPEG, GIF, PNG formats into an “RGB” format. This can be followed by applying the “SSDeep” hashing algorithm to the images as described above to make the matching process more tolerant of minor image alterations.

In yet other instances, fuzzy hashing can involve use of computer vision visual classifiers. The computer vision visual classifiers use artificial intelligence technologies such as Neural Networks that can “train” on the set of images and then successfully identify a similar image. In such instances, the computer vision visual classifiers involve use of digital image feature classifiers. Such feature-based methods are invariant to lighting conditions and the scale and/or position of visual objects in an image file. Several feature detection methods successfully used in image classification include: (i) Scale-invariant feature transform (SIFT)—In SIFT, keypoints of objects are first extracted from a set of reference images and stored in a database (e.g., illicit file database 234). An object is recognized in a new image by individually comparing each feature from an image under analysis to this database (e.g., illicit file database 234) and finding candidate matching features based on the Euclidean distance (defined as the distance between two points is the square root of the sum of the squares of the differences between the corresponding coordinates of the two points) of their feature vectors; (ii) Speeded up robust features (SURF)—SURF is a robust image detector and descriptor. The standard version of SURF is typically several times faster than SIFT and more robust against different image transformations than SIFT; (iii) 2D Haar wavelets—a Haar wavelet is a sequence of rescaled “square-shaped” functions that together forms a wavelet family or basis. Wavelet analysis is similar to Fourier analysis and allows a target function over an interval to be represented in terms of an orthonormal function basis. The Haar sequence is now recognized as the first known wavelet basis and extensively used as a teaching example.

In some instances, if there is an exact match of the hash value generated for a suspected illicit file stored in the communication device 210 to that of stored hash values of known illicit files as described above, the matching module 239 can generate an alert signal and produce an alert or forensic report associated with the match, and can send the alert signal and/or the alert or forensic report associated with the match, for example, to the communication device 210 and/or the law enforcement agency server 250 via the network 220. In other instances, the matching module 239 can compare the hash value of a suspected file with the stored hash values of known illicit files to get an approximate match (i.e., using the different fuzzy hashing methods as described above) such as for example, a 75% match, a 90% match, a 95% match, and/or the like (i.e., the threshold level of a match for a successful approximate match can be pre-determined and set, for example, by an administrator). In such instances, such approximate matches can also lead the matching module 239 to generate an alert signal and/or define an alert or forensic report associated with the said approximate match and can send the alert signal and/or the alert or forensic report associated with the approximate match to the communication device 210 and/or the law enforcement agency server 250 via the network 220.

In yet other instances, the matching module 239 can compare the hash value or hash string of a suspected illicit file to the hash values or hash strings defined by implementing a set of rules or concepts that are pre-defined by the administrator to determine a match level. Such rules or concepts can be represented by, for example, rule C1, C2, C3, and C4, where rule C1 can be defined as C1=C2 ‘OR’ C3 ‘OR’ C4. Note that the use of the Boolean logic “OR” is presented as a generic example only and not a limitation. In other instances, other Boolean and/or logical operators such as, for example, “AND”, “OR”, “NAND”, “NOR”, “XOR”, “XNOR” and “NOT” can be used to relate two separate rules or concepts and define a new rule or concept. For example, rule C2 can be defined as A ‘AND’ B (C2=A′ AND ‘B’), where ‘A’ and ‘B’ can refer to, for example, any features of a suspected illicit file stored in the communication device 110 such as, for example, the skin tone of a person in an image file, the facial features of a person in an image file, the density of hair of a person in an image file, the presence of sharp objects or features in an image file (e.g., objects that can represent a weapon), and/or a collection of one or more indicators, numbers or any other features that convey an idea or meaning in the suspected illicit file stored in the communication device 110 and/or obtained from the law enforcement agency server 250 and/or obtained from the Internet. Hence, the hashing module 238 can generate a hash value or string from implementing a set of pre-defined rules. For example, the hash value generated from implementing a set of rules associated with the skin tone of a person in an image file can have a first range of values, the hash value generated from implementing a set of rules associated with the facial features of a person in an image file can have a second range of values, the hash value generated from implementing a set of rules associated with the density of hair of a person in an image file can have a third range of values, and/or the like (where the first range of hash values, the second range of hash values and the third range of hash values are non-identical). The matching module 239 can then compare the said hash values generated from implementing the set of pre-defined rules with the hash values generated from the suspected illicit files. If the results of the comparison is above a pre-defined threshold value defined by the set of pre-defined rules or concepts, the matching module 239 can generate an alert signal and define an alert or forensic report associated with the match and can send the alert signal and/or the alert or forensic report associated with the match to the communication device 210 and/or the law enforcement agency server 250 via the network 220.

The hashing module 238 and the matching module 239 are able to perform hash value generation of any file stored in the communication device 110 and can perform hash value comparison with hash values of known illicit files to hash values generated from implementing a set of rules or concepts, respectively, in a stand-alone mode and also in a distributed environment. In the distributed computing environment, multiple computational nodes are geographically located remotely from each other, and each node has a distinct role in a computation problem or information processing. The transfer of files from the law enforcement agency server 250 and/or the communication device 210 to the enterprise server 230 can take place via, for example, the Secure File Transfer Protocol (SFTP), which is a network protocol that provides file access, file transfer, and file management functionalities over any reliable data stream.

The enterprise server 230 also includes a communication interface 240, which is operably coupled to the communication interfaces of the different servers and devices described in FIG. 2. The communication interface 240 can include one or multiple wireless port(s) and/or wired ports. The wireless port(s) in the communication interface 240 can send and/or receive data units (e.g., data packets) via a variety of wireless communication protocols such as, for example, a wireless fidelity (Wi-Fi®) protocol, a Bluetooth® protocol, a cellular protocol (e.g., a third generation mobile telecommunications (3G) or a fourth generation mobile telecommunications (4G) protocol), 4G long term evolution (4G LTE) protocol), and/or the like. In some instances, the wired port(s) in the communication interface 240 can also send and/or receive data units via implementing a wired connection to the law enforcement agency server 250 and/or the communication device 210. In such instances, the wired connections can be, for example, twisted-pair electrical signaling via electrical cables, fiber-optic signaling via fiber-optic cables, and/or the like.

The law enforcement agency server 250 can be, for example, a web server, an application server, a proxy server, a telnet server, a file transfer protocol (FTP) server, a mail server, a list server, a collaboration server and/or the like. The law enforcement agency server 250 can be associated with different law enforcement agencies such as, for example, the Federal Bureau of Investigation (FBI), the Drug Enforcement Administration (DEA), the Central Intelligence Agency (CIA), local police office, local Sheriff's office, a local Highway Petrol's office, and/or the like. The law enforcement agency server 250 includes a memory 251, a processor 255 and a communication interface 257. The memory 251 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 251 can store instructions to cause the processor 255 to execute modules, processes and/or functions associated with the law enforcement agency server 250 and/or the illicit file detection system 200. The memory 251 includes a criminal activity database 253.

The criminal activity database 253 can be a lookup table or a dedicated memory space that can, in some instances, store a set of hash values or hash strings of known illicit files such as, for example, child pornography files, files related to organized crime, files related to vandalism, crimes related to terrorism activity, files related to serial murders, and/or the like. The hash values of files stored in the criminal activity database 253 depends on the nature of the law enforcement agency as described above. For example, in some instances, the hash values of child pornography images and/or videos can be stored in the criminal activity database 253 if the law enforcement agency is the FBI, a local police office, a local Sheriff's office, a local Highway Petrol's office, and/or the like. In other instances, the hash values of terrorism-related files can be stored in the criminal activity database 253 if the law enforcement agency is the CIA, the FBI, and/or the like. In other instances, the data stored in the criminal activity database 253 can be the original known illicit files without any hashing algorithms implemented on the files.

In some instances, the criminal activity database 253 can also store the identities of known people associated with criminal activity such as, for example, child pornography, illegal gambling, terrorism, organized crime, and/or the like. In such instances, the criminal activity database 253 can store, for example, the name, the social security number, the date of birth, the place of birth, the driver's license number, arrest record locator number(s), police record number(s), a list of criminal activities associated with a criminal, a list of known illicit files that have been created or accessed by the criminal, and/or the like.

The processor 255 can be, for example, a general purpose processor, a Field Programmable Gate Array (FPGA), an Application Specific Integrated Circuit (ASIC), a Digital Signal Processor (DSP), and/or the like. The processor 255 can run and/or execute applications, modules, processes and/or functions associated with the law enforcement agency server 250 and/or the illicit file detection system 200. The processor 255 can access the data stored in the criminal activity database 253 and send the data to the enterprise server 230 for matching of the hash values of suspected illicit files stored in a communication device 110 of an organization with the stored hash values of known illicit files stored in the criminal activity database 253.

The law enforcement agency server 250 also includes a communication interface 257, which is operably coupled to the communication interfaces of the different servers and devices described in FIG. 2. The communication interface 257 can include one or multiple wireless port(s) and/or wired ports. The wireless port(s) in the communication interface 257 can send and/or receive data units (e.g., data packets) via a variety of wireless communication protocols such as, for example, a wireless fidelity (Wi-Fi®) protocol, a Bluetooth® protocol, a cellular protocol (e.g., a third generation mobile telecommunications (3G) or a fourth generation mobile telecommunications (4G) protocol), 4G long term evolution (4G LTE) protocol), and/or the like. In some instances, the wired port(s) in the communication interface 257 can also send and/or receive data units via implementing a wired connection to the enterprise server 230 and/or the communication device 210. In such instances, the wired connections can be, for example, twisted-pair electrical signaling via electrical cables, fiber-optic signaling via fiber-optic cables, and/or the like.

FIG. 2 shows the application 216 running locally on the communication device 210 and sending the hash values of suspected files stored in the communication device to the enterprise device 230 for matching with hash values of known illicit files. The configuration described in FIG. 2 is presented as an example only, and not a limitation. In other embodiments, the application can be a hardware module(s) and/or software module(s) stored in the memory 232 and/or executed in the processor 235 of the enterprise server 230 (i.e., not running locally on the communication device 210) and be part of the application manager 236. In such embodiments, the application manager 236 can remotely access the different files stored in the communication device 210 (e.g., via the network 220), define a hash value or a hash string for the suspected illicit file and compare the hash value generated for the suspected illicit file to the hash values of known illicit files that are stored in the illicit file database 234 of the enterprise server 230. In such configurations, all the files of the different communication devices associated with an organization are being remotely accessed by the enterprise server 230, hashed remotely by the enterprise server 230, and compared to known illicit files remotely by the enterprise server 230 without active knowledge of any users of the communication devices.

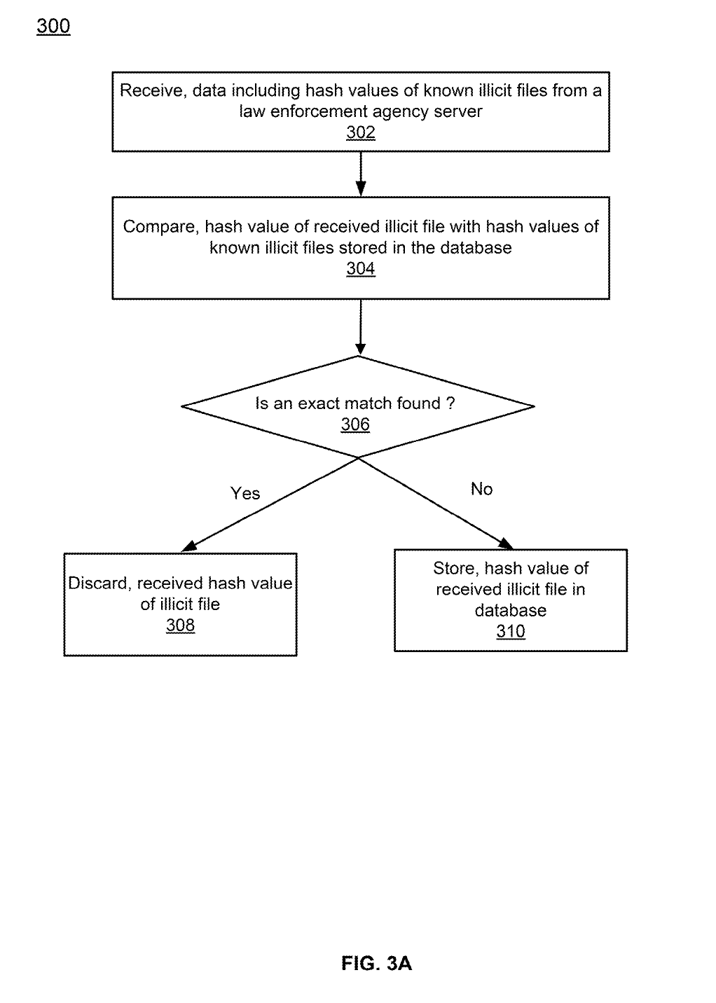

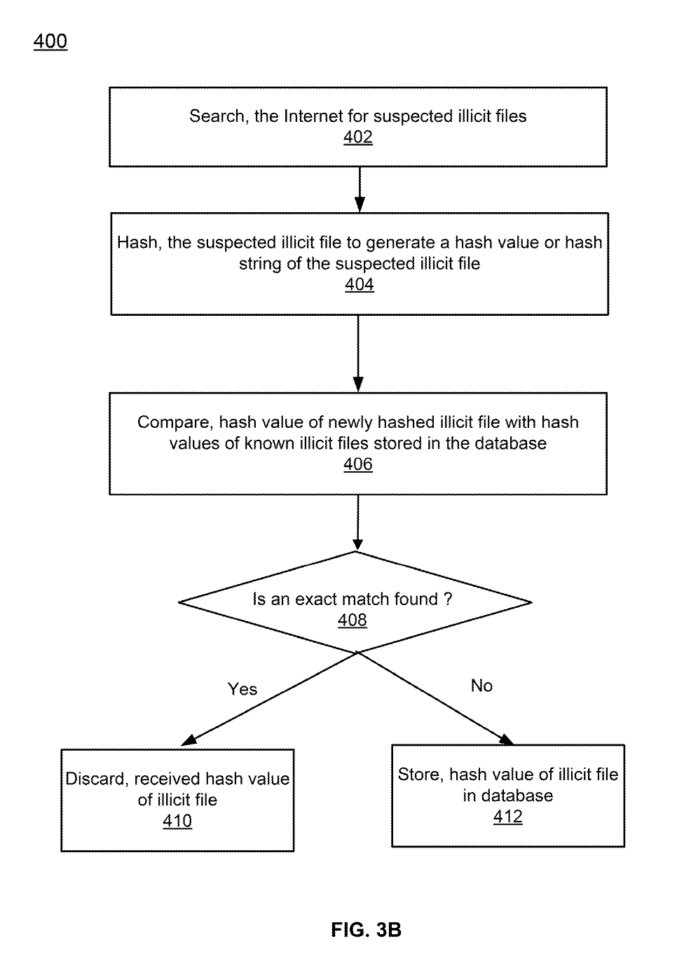

FIG. 3A is a flow chart illustrating a method for storing known illicit files in the database of the enterprise server, according to a first configuration. The method 300 includes receiving, data including hash values of known illicit files from a law enforcement agency server, at 302. Such data can be received by, for example, the enterprise server of the illicit file detection system (described in FIG. 2). As described above, the enterprise server can be, for example, a web server, an application server, a proxy server, a telnet server, a file transfer protocol (FTP) server, a mail server, a list server, a collaboration server and/or the like. As described above, the law enforcement agency server can be associated with, for example, different law enforcement agencies such as, for example, the FBI, the DEA, the CIA, local police office, local Sheriff's office, a local Highway Petrol's office, and/or the like. As described above, the transfer of files from the law enforcement agency server 250 and/or the communication device 210 to the enterprise server can take place via, for example, the SFTP protocol, which is a network protocol that provides file access, file transfer, and file management functionalities over any reliable data stream.

At 304, the hash value of received illicit file is compared or matched with the hash values of known illicit files stored in the database. As described above, such comparison or matching can be performed at, for example, the matching module of the enterprise server. As described above, the matching module of the enterprise server can use multiple hash value comparison technologies to compare the hash values generated for an illicit file (received from a law enforcement agency server) to the stored hash values of known illicit files stored in, for example, the illicit file database of the enterprise server. As described above, in some instances, it is desirable for the matching module of the enterprise server to be able to perform fast comparison of calculated on-the-fly hash values of an illicit file with the hash values of files stored in, for example, the illicit file database of the enterprise server. At 306, a determination is made if the received hash value of the illicit file has an exact match with a hash value of an illicit file stored in, for example, the illicit file database of the enterprise server. Such determination can be made at, for example, the matching module of the enterprise server.

If an exact match is found between the received hash value of the illicit file and a hash value of an illicit file stored in, for example, the illicit file database of the enterprise server, the received hash value of the illicit file is discarded, at 308. If an exact match is not found between the received hash value of the illicit file and a hash value of an illicit file stored in, for example, the illicit file database of the enterprise server, the received hash value of the illicit file is stored at, for example, the illicit file database of the enterprise server, at 310.

FIG. 3B is a flow chart illustrating a method for storing known illicit files in the database of the enterprise server, according to a second configuration. The method 400 includes searching the Internet for suspected illicit files, at 402. As described above, the search can be performed by, for example, a search engine in the enterprise server of the illicit file detection system. The search engine can analyze features of a suspected illicit file anywhere on the Internet such as, for example, the skin tone of a person in an image file, the facial features of a person in an image file, the density of hair of a person in an image file, the presence of sharp objects or features in an image file (e.g., objects that can represent a weapon), and/or a collection of one or more signs, numbers or any other features that convey an idea or meaning that the suspected file can be a potentially illicit file. Additionally, the search engine can also search for illicit files stored in the different communication devices associated with a network (e.g., communication device in 210 in FIG. 2) and analyze features of the suspected illicit files.

At 404, the suspected illicit file is hashed at, for example, the hashing module of the enterprise server to generate a hash value or hash string of the suspected illicit file. As described above, the hashing module can apply a hash function to the suspected file to generate a fixed-sized bit string (i.e., the hash value or the hash string), such that any (accidental or intentional) change to the data associated with the file will (with very high probability) change the hash value of the file. As described above, the data in the file that is encoded by the hashing module in such a manner that: is infeasible to re-generate the file back from its given hash value; it is infeasible to modify a file without changing the hash value of the file, and; it is infeasible to find two different files with the same hash value. As described above, the hashing module can implement high sensitivity and selectivity hash function generation techniques to create the hash value or hash sting of a file using modern multipart hashes and hierarchical hash chains (e.g., MD5, SHA-1, SHA256, SSDeep, etc.).

At 406, the hash value of suspected file is compared or matched with the hash values of known illicit files stored in the database. As described above, such comparison or matching can be performed at, for example, the matching module of the enterprise server. As described above, the matching module of the enterprise server can use multiple hash value comparison technologies to compare the hash values generated of a suspected file (received from the Internet) to the stored hash values of known illicit files stored in, for example, the illicit file database of the enterprise server. At 408, a determination is made if the hash value of the suspected file has an exact match with a hash value of an illicit file stored in, for example, the illicit file database of the enterprise server. Such determination can be made at, for example, the matching module of the enterprise server.

If an exact match is found between the hash value of the suspected file and a hash value of an illicit file stored in, for example, the illicit file database of the enterprise server, the hash value of the suspected file is discarded, at 410. If an exact match is not found between the hash value of the suspected file and a hash value of an illicit file stored in, for example, the illicit file database of the enterprise server, the hash value of the suspected file is stored at, for example, the illicit file database of the enterprise server, at 412.

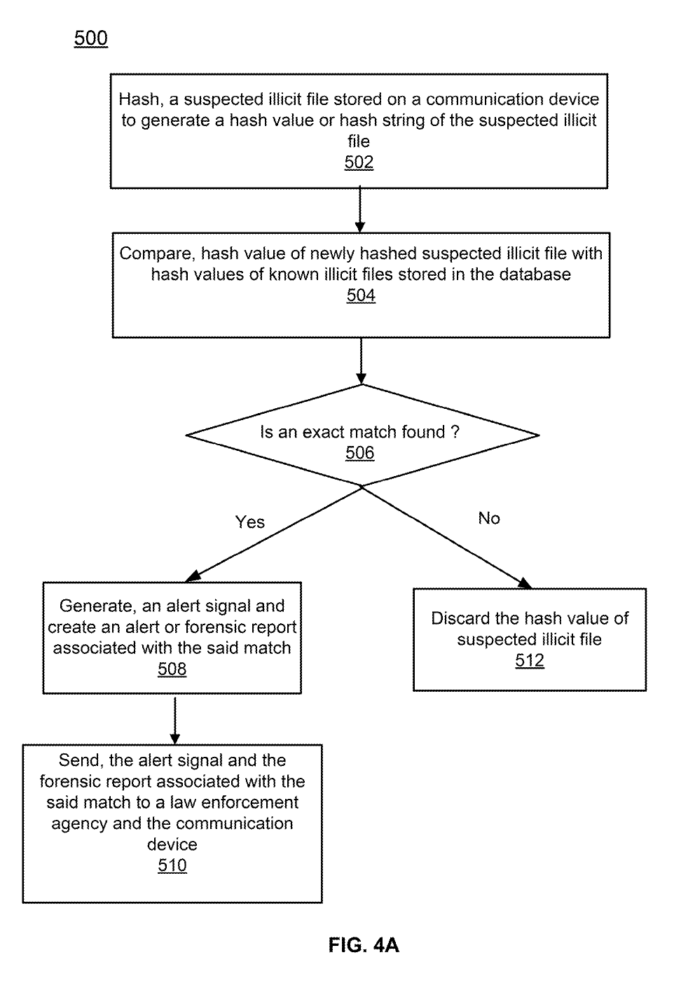

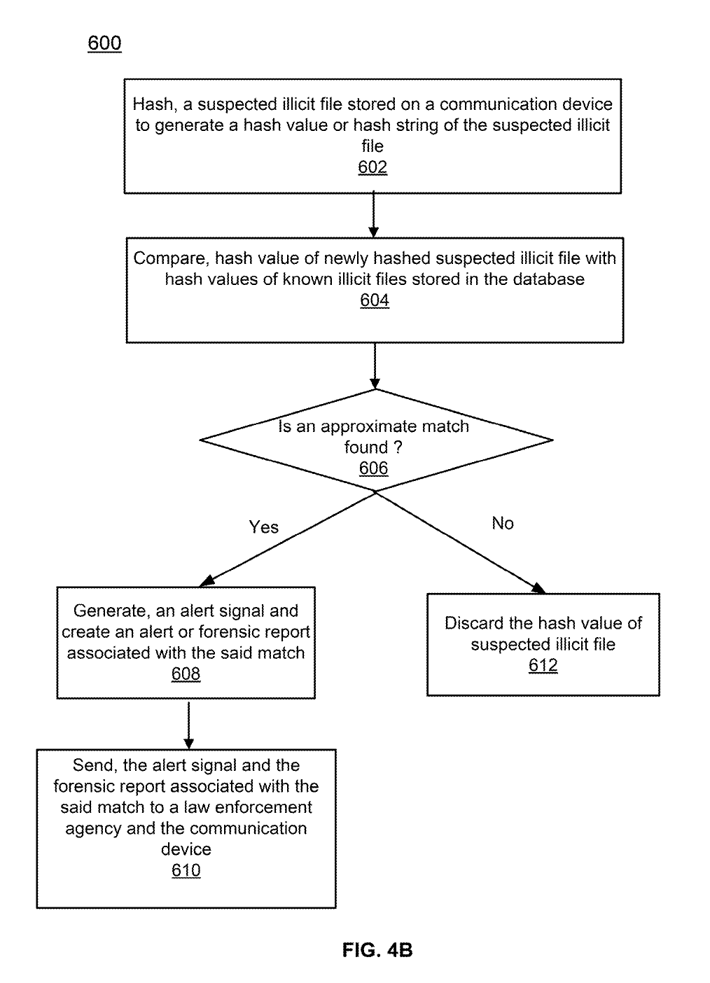

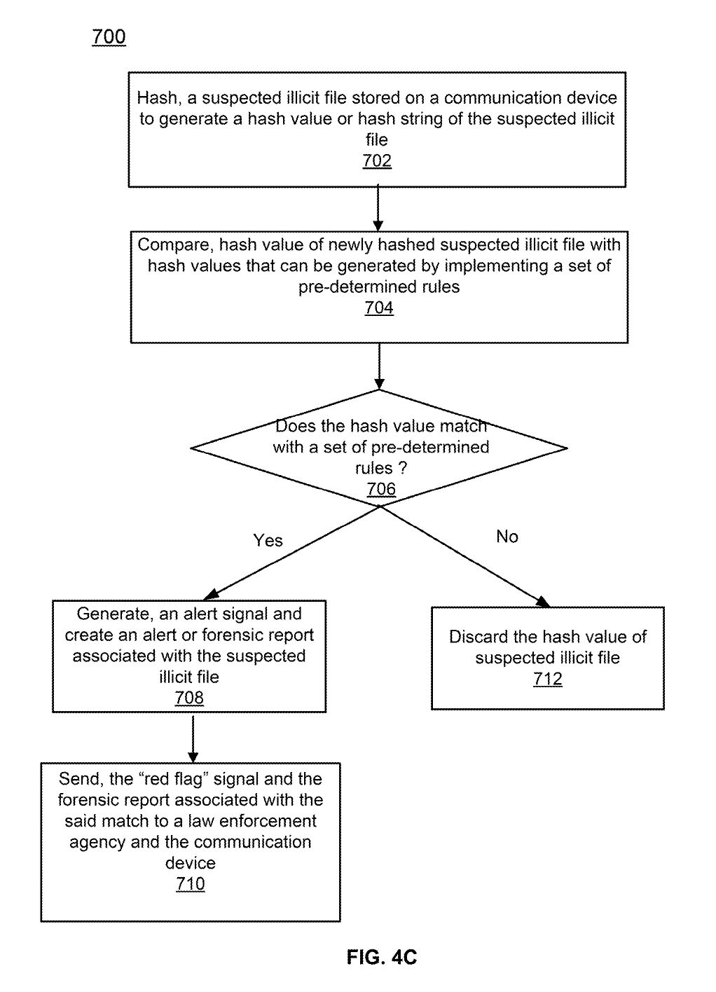

FIG. 4A is a flow chart illustrating a method for detecting the presence of a suspected illicit file in a communication device, according to a first configuration. The method 500 includes hashing, a suspected illicit file stored in a communication device to generate a hash value or hash string of the suspected illicit file, at 502. As described above, the hashing can be performed by an application running (or executing) locally on the communication device. As described above, the communication device can be associated with a physical or logical storage component or device or a portion of a logical memory that can be located on a personal communication device, a communication device associated with any type of network (e.g., LAN, WAN, etc.) and/or a communication device associated with a cloud computing network. For example, in some instances, the communication device can be any personal communication device such as a desktop computer, a laptop computer, a PDA, a standard mobile telephone, a tablet PC, and/or so forth. In other instances, the communication device can be an enterprise computing device/system such as a database, a server, a SAN, and/or the like. As described above, the communication device can be associated with, for example, any corporate enterprise, K-12 educational institution, university, community college, medical service provider, government organization, and/or the like. As described above, the application can include a hashing engine that can apply a hash function to any arbitrary file stored in the communication device to generate a fixed-sized bit string (i.e., the hash value or the hash string), such that any (accidental or intentional) change to the data associated with the file will (with very high probability) change the hash value of the file. As described above, the hash value for suspected illicit file is generated by the application in such a manner that: is infeasible to re-generate the file back from its given hash value; it is infeasible to modify a file without changing the hash value of the file, and; it is infeasible to find two different files with the same hash value. As described above, the application can then send the newly generated hash value of the suspected illicit file to the enterprise server via, for example, the network.

At 504, the hash value of suspected illicit file is compared or matched with the hash values of known illicit files stored in the database. As described above, such comparison or matching can be performed at, for example, the matching module of the enterprise server. As described above, the matching module of the enterprise server can use multiple hash value comparison technologies to compare the hash values generated of a suspected file (received from the communication device) to the hash values of known illicit files stored in, for example, the illicit file database of the enterprise server. At 506, a determination is made if the hash value of the suspected illicit file has an exact match with a hash value of a known illicit file stored in, for example, the illicit file database of the enterprise server. As described above, such determination can be made at, for example, the matching module of the enterprise server.

If an exact match is found between the hash value of the suspected illicit file and a hash value of an illicit file stored in the illicit file database of the enterprise server, at 508, an alert signal and an alert or forensic report associated with the match can be generated by, for example, the matching module of the enterprise server. At 510, the alert signal and the alert or forensic report associated with the exact match are sent to a law enforcement agency server via the network by, for example, the enterprise server. If an exact match is not found between the hash value of the suspected illicit file and a hash value of an illicit file stored in the illicit file database of the enterprise server, at 512, a signal representing the non-match event is sent from, for example, the enterprise server to, for example, the application running locally on the communication device, and the hash value of the suspected illicit file is discarded by, for example, the application.

FIG. 4B is a flow chart illustrating a method for detecting the presence of a suspected illicit file in a communication device, according to a second configuration. The method 600 includes hashing, a suspected illicit file stored in a communication device to generate a hash value or hash string of the suspected illicit file, at 602. As described above, the hashing can be performed by an application running locally on the communication device as described in relation FIGS. 2 and 4A above. As described above, the application can then send the hash value of the suspected illicit file to the enterprise server via, for example, the network.

At 604, the hash value of suspected illicit file is compared or matched with the hash values of known illicit files stored in, for example, the illicit file database of the enterprise server. As described above, such comparison or matching can be performed at, for example, the matching module of the enterprise server. As described above, the matching module can execute a myriad of fuzzy hashing match algorithms to help detect altered and modified forms of known (original) illicit files that are stored in the communication device (e.g., a cropped known illicit image file, a known illicit image file with different brightness levels, a known illicit image file with different contrast levels, a known illicit image file generated by software filtering, etc.). As described above, the fuzzy hashing can be performed at, for example, the hashing module of the enterprise server and the comparison of fuzzy hashed value can be performed in the matching module of the enterprise server. Such matching or comparisons can allow for the discovery of potentially incriminating illicit files (e.g., image files, WORD files, PDF files, spreadsheets, etc.) that may not be identified using traditional hashing and comparison methods. At 606, a determination is made if the hash value of the suspected illicit file has an approximate match with a hash value of a known illicit file stored in, for example, the illicit file database of the enterprise server. As described above, the approximate match can be, for example, a 75% match, a 90% match, a 95% match, and/or the like (i.e., the threshold level of a match for a successful approximate match can be pre-determined and set by an administrator).

In some instances, if there is an approximate match of the hash value generated for the suspected file stored in the communication device to a hash value of a known illicit file stored in, for example, the illicit file database of the enterprise server, at 608, an alert signal and an alert or forensic report associated with the approximate match can be generated by, for example, the matching module of the enterprise server. At 610, the alert signal and the alert or forensic report associated with the approximate match are sent to a law enforcement agency server via the network by, for example, the enterprise server. If an approximate match is not found between the hash value of the suspected file and a hash value of an illicit file stored in the illicit file database of the enterprise server, at 612, a signal representing the non-match event is sent from, for example, the enterprise server to, for example, the application running locally on the communication device, and the hash value of the suspected illicit file is discarded by, for example, the application.

FIG. 4C is a flow chart illustrating a method for detecting the presence of a suspected illicit file in a communication device, according to a third configuration. The method 700 includes hashing, a suspected illicit file stored in a communication device to generate a hash value or hash string of the suspected illicit file, at 702. As described above, the hashing can be performed by an application running locally on the communication device as described in relation FIGS. 2, 4A and 4B above. As described above, the application can then send the hash value of the suspected illicit file to the enterprise server via, for example, the network.

At 704, the hash value of suspected illicit file is compared or matched with the hash values or hash strings that can be generated by implementing a set of pre-determined rules or concepts. As described above, such comparison or matching can be performed at, for example, the matching module of the enterprise server. As described above, such rules or concepts can be represented by, for example, rule C1, C2, C3, and C4, where rule C1 can be defined as C1=C2 ‘OR’ C3 ‘OR’ C4. As described above, Boolean and/or logical operators other than ‘OR’ can be used to relate two separate rules or concepts and define a new rule or concept such as, for example, “AND”, “OR”, “NAND”, “NOR”, “XOR”, “XNOR” and “NOT”. For example, rule C2 can be defined as A ‘AND’ B (C2=A′ AND ‘B’), where ‘A’ and ‘B’ can refer to, for example, any features of a suspected file stored in the communication device such as, for example, the skin tone of a person in an image file, the facial features of a person in an image file, the density of hair of a person in an image file, the presence of sharp objects or features in an image file (e.g., objects that can represent a weapon), and/or a collection of one or more indicators, numbers or any other features that convey an idea or meaning in suspected file stored in the communication device. Hence, as described above, the hashing module can generate a hash value or string from implementing a set of pre-defined rules. For example, the hash value generated from implementing a set of rules associated with the skin tone of a person in an image file can have a first range of values, the hash value generated from implementing a set of rules associated with the facial features of a person in an image file can have a second range of values, the hash value generated from implementing a set of rules associated with the density of hair of a person in an image file can have a third range of values, and/or the like. The matching module can then compare the said hash values generated from implementing the set of pre-defined rules with the hash values generated from the suspected illicit files stored in the communication device. At 706, a determination is made if the hash value of the suspected illicit file has a match with the hash values or hash strings generated by implementing the set of pre-determined rules or concepts. As described above, such determination can be made at, for example, the matching module of the enterprise server.

In some instances, if there is a match between the hash value of the suspected illicit file with the hash value or hash strings generated by implementing the set of pre-determined rules or concepts, at 708, an alert signal and an alert or forensic report associated with the match can be generated by, for example, the matching module of the enterprise server. At 710, the alert signal and the alert or forensic report associated with the match are sent to a law enforcement agency server via the network by, for example, the enterprise server. In other instances, if there is no match between the hash value of the suspected illicit file with the hash value or hash string generated by implementing the set of pre-determined rules or concepts, at 712, a signal representing the non-match event is sent from, for example, the enterprise server to, for example, the application running locally on the communication device, and the hash value of the suspected illicit file is discarded by, for example, the application.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

What is claimed is:

1. A non-transitory processor-readable medium storing code representing instructions to be executed by a processor, the code comprising code to cause the processor to:
generate a plurality of hash values for a suspected illicit file that is stored in a communication device in a computer network, each hash value from the plurality of hash values for the suspected illicit file being associated with at least one feature of the suspected illicit file;
define a match value by comparing, in accordance with a rule, the plurality of hash values of the suspected illicit file to a list of hash values of known illicit files stored in a database, each hash value from the list of hash values of the known illicit files being associated with at least one feature of at least one of the known illicit files; and
if the match value of the suspected illicit file is above a threshold, generate an alert signal identifying the suspected illicit file as a possible illicit file.

2. The non-transitory processor-readable medium storing code representing instructions to be executed by a processor of claim 1, wherein the match value is above the threshold when at least two hash values from the plurality of hash values for the suspected illicit file match at least two hash values from the list of hash values of known illicit files.

3. The non-transitory processor-readable medium storing code representing instructions to be executed by a processor of claim 1, the code further comprising code to cause the processor to search the communication device in the computer network to locate a copy of the suspected illicit file.

4. The non-transitory processor-readable medium storing code representing instructions to be executed by a processor of claim 1, wherein the at least one feature of the suspected illicit file is at least one of a skin tone of a person in an image file, a plurality of facial features of the person in the image file, a density of hair of the person in the image file, a presence of sharp objects or sharp features in the image file.

5. The non-transitory processor-readable medium storing code representing instructions to be executed by a processor of claim 1, wherein the illicit file is one of a video file, an image file, or an audio file.

6. A method, comprising:
generating, at a server device, a hash value of a suspected illicit file stored in a communication device in a computer network;
comparing, at the server device, the hash value of the suspected illicit file to a list of hash values of known illicit files stored in a database to produce an approximate match value;
if the hash value of the suspected illicit file has an approximate match value with any hash value from the list of the known illicit files that is above a first threshold but lower than a second threshold, generating an alert signal associated with identifying the suspected illicit file as a possible illicit file; and
if the hash value of the suspected illicit file has the approximate match value with any hash value from the list of the known illicit files that is above the second threshold, generating an alert signal associated with the match and identifying the suspected illicit file as an illicit file.

7. The method of claim 6, further comprising scanning a storage device of the communication device to locate the suspected illicit file.

8. The method of claim 6, further comprising receiving, from the communication device, the suspected illicit file.

9. The method of claim 6, further comprising, when the hash value of the suspected illicit file has the approximate match value that is above the second threshold with any hash value from the list of the known illicit files, adding the hash value of the suspected illicit file to the list of hash values of known illicit files.

10. The method of claim 6, further comprising if the hash value of the suspected illicit file has the approximate match value that is below the first threshold, discarding the hash value of the suspected illicit file.

11. The method of claim 6, wherein the list of hash values of known illicit files is a first list of hash values of known illicit files, the method further comprising:
receiving a hash value of a known illicit file;
comparing the hash value of the known illicit file to the hash values from the first list of hash values of known illicit files; and
if the hash value of the known illicit file does not match any hash value from the first list of hash values, adding the hash value of the known illicit file to the first list of hash values of known illicit files to define a second list of hash values of known illicit files.

12. The method of claim 6, wherein the illicit file is one of a video file, an image file, or an audio file, and depicts an illegal activity.

13. The method of claim 6, further comprising sending the alert signal to a compute device of a law enforcement agency and not sending the alert signal to the communication device.

14. The method of claim 6, wherein generating the hash value of the suspected illicit file includes generating the hash value of the suspected illicit file using an SSDeep hashing algorithm.

15. An apparatus, comprising:
a processor operatively coupled to a memory and configured to execute a hashing module and a matching module;
the hashing module configured to receive a hash value of a known illicit file;
the matching module configured to compare the hash value of the known illicit file to a first list of hash values of known illicit files stored in a database;
if the hash value of the known illicit file does not match any hash value from the first list of hash values, the matching module configured to add the hash value of the known illicit file to the first list of hash values of known illicit files to define a second list of hash values of known illicit files;
the hashing module configured to generate a hash value a suspected illicit file;
the matching module configured to compare the hash value of the suspected illicit file to the second list of hash values of known illicit files stored in a database to produce an approximate match value;
if the hash value of the suspected illicit file has the approximate match value with any hash value from the second list of the known illicit files that is above a threshold, the matching module configured to generate an alert signal identifying the suspected illicit file as an illicit file.

16. The apparatus of claim 15, further comprising a search engine executed by the processor and configured search a wide area network to find the suspected illicit file.

17. The apparatus of claim 15, further comprising a search engine executed by the processor and configured search a communication device in a computer network to find the suspected illicit file.

18. The apparatus of claim 15, wherein:
the threshold is a first threshold,
if the hash value of the suspected illicit file has an approximate match value with any hash value from the second list of the known illicit files that is above a second threshold but below the first threshold, the matching module configured to generate an alert signal associated with the match and identifying the suspected illicit file as a probable illicit file.

19. The apparatus of claim 15, wherein the hashing module is configured to generating the hash value of the suspected illicit file using an SSDeep hashing algorithm.

20. The apparatus of claim 15, wherein the hashing module is configured to receive the known illicit file from a compute device of a law enforcement agency.

21. The apparatus of claim 15, wherein the known illicit file is one of a video file, an image file, or an audio file, and depicts an illegal activity.
